(19) United States
(12) Patent Application Publication
(10) Pub. No.: US 2024/0113310 A1
(43) Pub. Date: Apr. 4, 2024

(54) FUEL CELL SYSTEM AND METHOD FOR EXHAUSTING HYDROGEN THEREIN

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/463,511

(22) Filed: Sep. 8, 2023

(30) Foreign Application Priority Data
Oct. 4, 2022 (KR) 10-2022-0126109

(51) Int. Cl. H01M 8/04119; B60L 58/12; B60L 58/30; B60L 58/40; H01M 8/04223; H01M 8/04746

(52) U.S. Cl. CPC H01M 8/04119; B60L 58/12; B60L 58/30; B60L 58/40; H01M 8/04231; H01M 8/04753; H01M 2250/20

(57) ABSTRACT

A fuel cell system including a hydrogen exhaust valve provided in an outlet of a hydrogen tank, the hydrogen tank configured to supply hydrogen to a fuel cell stack, the hydrogen exhaust valve being configured to exhaust remaining hydrogen in the hydrogen tank to an outside, and a controller configured to diagnose a fault cause when a fault occurs during a flight of a flying object associated with the fuel cell stack, perform an exhaust operation on the hydrogen stored in the hydrogen tank responsive to the fault cause, and control the hydrogen exhaust valve according to the exhaust operation.

### CROSS-REFERENCE TO RELATED APPLICATION

This application claims the benefit under 35 USC § 119(a) of Korean Patent Application No. 10-2022-0126109, filed in the Korean Intellectual Property Office on Oct. 4, 2022, the entire disclosure of which is incorporated herein by reference for all purposes.

### BACKGROUND

### 1. Field

The present disclosure relates to a fuel cell system and a method for exhausting hydrogen therein.

### 2. Description of the Related Art

A fuel cell system may generate electrical energy using a fuel cell stack. For example, when hydrogen is used as the fuel of a fuel cell stack, hydrogen may be an alternative for a global environment problem. Accordingly, studies and researches for the fuel cell system have been consecutively performed.

The fuel cell system includes a fuel cell stack which generates electrical energy, a fuel supply which supplies fuel (hydrogen) to the fuel cell stack, an air supply which supplies oxygen in the air serving as an oxidant necessary for electrochemical reactions, and a thermal management system (TMS) which removes reaction heat from the fuel cell stack to discharge the reaction heat of the fuel cell stack to the outside of the system, controls an operating temperature of the fuel cell stack, and performs a water managing function. The fuel cell system generates electricity by making reaction between hydrogen, which serves as fuel, and oxygen in the air in a fuel cell stack, and exhaust heat and water which are by-products.

Recently, the fuel cell system has been applied various moving units such as a flying object as well as a vehicle. However, since the flying object flies on the sky having a specific height, the flying object may be fallen when the flying object is faulted.

The fuel cell system stores hydrogen in a hydrogen tank and supplies the stored hydrogen to a fuel cell stack to generate power to be supplied to the flying object. When the flying object is fallen due to the fault thereof, hydrogen in the hydrogen tank may be exploded due to the impact caused in crash.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. In a general aspect, here is provided a fuel cell system including a hydrogen exhaust valve provided in an outlet of a hydrogen tank, the hydrogen tank configured to supply hydrogen to a fuel cell stack, the hydrogen exhaust valve being configured to exhaust remaining hydrogen in the hydrogen tank to an outside, and a controller configured to diagnose a fault cause when a fault occurs during a flight of a flying object associated with the fuel cell stack, perform an exhaust operation on the hydrogen stored in the hydrogen tank responsive to the fault cause, and control the hydrogen exhaust valve according to the exhaust operation.

The controller may be further configured to diagnose the fault cause, based on information on a state of the flying object, information being received through a communication with a vehicle controller of the flying object.

The fuel cell system may include a high voltage battery configured to be charged with regenerative braking energy of the fuel cell stack, and to supply a propulsion power to the flying object responsive to the fault cause being a fault from the fuel cell stack.

The controller may be further configured to switch a power supply mode to a high-voltage battery use mode when the fault cause of the flying object is the fault from the fuel cell stack and perform a first control operation responsive to a state of charge (SoC) of the high voltage battery satisfying a condition of being capable of flying for a remaining flight distance.

The controller may be further configured to stop a charging of the high voltage battery with the regenerative braking energy of the fuel cell stack and supply the propulsion power of the flying object for an emergency landing operation of the flying object using a charging power of the high voltage battery, when the first control operation is performed.

The controller may be further configured to terminate an operation of a power electronic part drawing a power of the high voltage battery, when the first control operation is performed.

The controller may be further configured to monitor the SoC of the high voltage battery and determine a remaining amount of hydrogen in the hydrogen tank during the first control operation.

The controller may be further configured to, when the first control operation is performed, close a hydrogen tank valve supplying the hydrogen to the fuel cell stack, and open the hydrogen exhaust valve.

The controller may be further configured to perform a second control operation, when the fault cause of the flying object is responsive to a defect of a vehicle body of the flying object.

The controller may be further configured to, during the second control operation, open the hydrogen exhaust valve and open a fuel supply valve to adjust supply of the hydrogen to the fuel cell stack, and a purge valve, to perform a purge operation for the fuel cell stack.

The purge operation may be configured to fully discharge the hydrogen in a minimum amount of time.

The controller may be further configured to operate an air supply pump to supply air to the fuel cell stack to output a maximum power, when the second control operation is performed.

The controller may be further configured to charge a high voltage battery with the power generated in the fuel cell stack, when the second control operation is performed.

The controller may be further configured to perform the second control operation, when the fault cause of the flying object is a fault of the fuel cell stack, and when a state of charge (SoC) of a high voltage battery does not satisfy a condition being capable of flying driving to a remaining flight distance.

The hydrogen exhaust valve may include a direct current (DC) motor.

The exhaust value may include an H-bridge circuit to control a rotating operation of the DC motor.

In a general aspect, here is provided a method for exhausting hydrogen in a fuel cell system including diagnosing a fault cause when a fault occurs during a flight operation of a flying object being propelled with power generated in a fuel cell stack, performing an operation of controlling an exhaust of the hydrogen responsive to a diagnosis result, and controlling a hydrogen exhaust valve to exhaust remaining hydrogen in a hydrogen tank to an outside.

The controlling of the hydrogen exhaust valve includes switching a power supply mode to a high-voltage battery use mode when the fault cause of the flying object is a fuel cell stack fault, performing a first control operation, when a state of charge (SoC) of the high voltage battery satisfies a flying condition for a remaining flight distance, and performing a second control operation, when the fault cause of the flying object is a vehicle body fault of the flying object.

The performing of the first control operation may include stopping a charging of the high voltage battery from a regenerative braking energy of the fuel cell stack, initiating supplying the propelling power of the flying object from the high voltage battery, terminating an operation of one or more power electronic parts drawing power of the high voltage battery, closing a hydrogen tank valve supplying the hydrogen to the fuel cell stack, and opening the hydrogen exhaust valve, and monitoring the SoC of the high voltage battery to determine a remaining amount of hydrogen in the hydrogen tank.

The performing of the second control operation may include opening the hydrogen exhaust valve, opening a fuel supply valve, to adjust a supply of the hydrogen to the fuel cell stack, and a purge valve to perform a maximum purge operation for the fuel cell stack, operating an air supply pump to supply air to the fuel cell stack to output a maximum power, and charging the high voltage battery with the power generated in the fuel cell stack.

The controlling of the hydrogen exhaust valve may include performing the second control operation, when the fault cause of the flying object is the fuel cell stack fault, and when a state of charge (SoC) of the high voltage battery to supply propulsive power to the flying object does not satisfy a condition for fight to a remaining flight distance.

In a general aspect, here is provided a processor-implemented method including monitoring for faults during a flight operation of a flying vehicle being propelled by a fuel cell stack employing a hydrogen tank storing hydrogen and a battery being charged with regenerative braking energy from the fuel cell stack and, responsive to a fuel cell stack fault, entering an emergency landing operation, the emergency landing operation including controlling a valve of the hydrogen tank to release the hydrogen.

The method may include, responsive to a flying body fault, entering an emergency venting operation, the emergency venting operation including performing a purge operation to release the hydrogen.

The purge operation may include opening a hydrogen exhaust value to vent the hydrogen from the hydrogen tank, closing off a supply of the hydrogen to the fuel cell stack, suppling air to the fuel cell stack via an air supply pump, and charging the battery with power from the fuel cell stack.

The emergency landing operation further may include ceasing the battery being charged with the regenerative braking energy, switching to a propulsion power supplied by the battery, switching off one or more power electronic parts of the flying vehicle being powered by the battery, closing a supply of hydrogen from the hydrogen tank to the fuel cell stack, and opening a hydrogen exhaust value to vent the hydrogen from the hydrogen tank.

### BRIEF DESCRIPTION OF THE DRAWINGS

FIG. 1 is a view illustrating a fuel cell system, according to an embodiment of the present disclosure;

FIG. 2 is a view illustrating a control structure of a hydrogen exhaust valve, according to an embodiment of the present disclosure;

FIG. 3 is a view illustrating a control operation of a hydrogen exhaust valve, according to an embodiment of the present disclosure;

FIG. 4A is a view illustrating a hydrogen exhaust operation of a fuel cell system, according to an embodiment of the present disclosure;

FIG. 4B is a view illustrating a hydrogen exhaust operation of a fuel cell system, according to another embodiment of the present disclosure; and

FIG. 5 is a flowchart illustrating the operation of a hydrogen exhaust method of a fuel cell system, according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

A fuel cell system according to the present disclosure may be applicable to a flying object flying on the sky. Although the fuel cell system is provided at a lower portion of the flying object in the following description of embodiments, the placement position and the size of the fuel cell system illustrated in accompanying drawings are merely provided for the convenience of explanation, and the present disclosure is not limited thereto. For example, the fuel cell system may be provided inside or outside of the flying object, and the size of the fuel cell system may be adjusted.

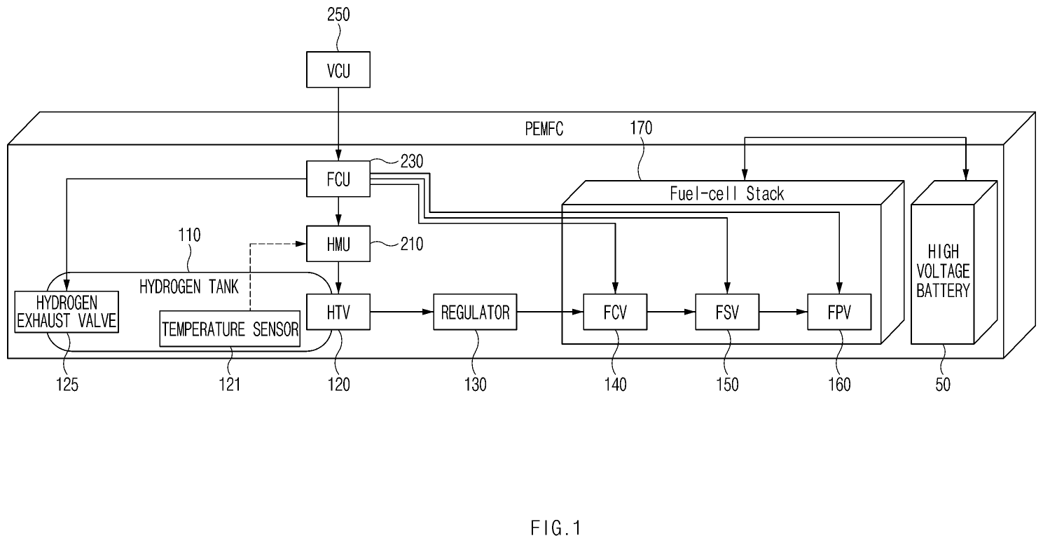

FIG. 1 is a view illustrating a fuel cell system, according to an embodiment of the present disclosure.

Referring to FIG. 1, the fuel cell system may include a fuel cell stack 170, and may further include a hydrogen supply line connected to a hydrogen electrode of the fuel cell stack 170 to allow hydrogen to move and be supplied to the fuel cell stack 170, an air supply line connected to the cathode of the fuel cell stack 170 to move air to be supplied to the fuel cell stack 170, and an exhaust line and a purge line for exhaust moisture (water), which is a by-product of a reaction, or a non-reacted gas, to the outside.

The fuel cell stack 170 (or may be referred to as a ‘fuel cell’) may be formed in a structure for generating electricity through an oxidation-reduction reaction between fuel (e.g., hydrogen) and an oxidizing agent (e.g., air). For example, the fuel cell stack 170 may be a polymer electrolyte membrane fuel cell (PEMFC).

The fuel cell stack 170 may include a membrane electrode assembly (MEA) having catalyst electrode layers attached to opposite sides of an electrolyte membrane for transferring hydrogen ions, a gas diffusion layer (GDL) to uniformly distribute reaction gases and transfer the generated electrical energy, a gasket and clamping mechanism to maintain airtightness and proper clamping pressure of reaction gases and cooling water a bipolar plate to transfer the reaction gases and the cooling water.

In the fuel cell stack 170, the hydrogen serving as fuel and the air (oxygen) serving as the oxidizing agent may be supplied to an anode and a cathode of the MEA through a fluid passage of the bipolar plate. For example, the hydrogen may be supplied to an anode serving as a hydrogen electrode and the air may be supplied to a cathode serving as an air electrode.

The hydrogen, which is supplied to the anode, is decomposed into a proton and an electron through catalysts provided at opposite sides of an electrolyte film. Among them, only a hydrogen ion selectively passes through the electrolyte film, which is a cation exchange membrane, and is transmitted to the cathode while the electron is transmitted to the cathode through a gas diffusion layer and the bipolar plate. In the cathode, the hydrogen ions supplied through the electrolyte film and the electrons received through the bipolar plate meet oxygen of the air supplied to the cathode through an air supply device, thereby generating water. In this case, the electrons may flow through an external conductive line due to the transfer of the hydrogen ions, and the flow of the electrons may generate a current.

In addition, the fuel cell system may include a hydrogen tank 110, and may further include a hydrogen tank valve (HTV) 120, a regulator 130, a fuel cut-off valve (FCV) 140, and a fuel supply valve (FSV) 150 placed on the hydrogen supply line connecting the hydrogen tank 110 to the anode of the fuel cell stack 170. Although not illustrated in FIG. 1, the hydrogen supply line may further include units, which are a pressure regulating valve (PRV), a medium pressure sensor (MP), and a fuel ejector (FEJ) necessary to supply hydrogen to the fuel cell stack 170.

The hydrogen tank 110, which serves as a reservoir to store fuel, that is hydrogen, supplied to the anode of the fuel cell stack 170, exhausts the stored hydrogen to the hydrogen supply line, when the hydrogen is required to be supplied to the fuel cell stack 170. The hydrogen tank 110 may be charged with hydrogen introduced to be charged through a hydrogen charging port. In addition, the hydrogen tank 110 may have a temperature sensor 121 provided therein to sense the internal temperature of a tank.

The HTV 120 may be provided in an outlet of the hydrogen tank 110. In this case, the HTV 120 may adjust an amount of hydrogen supplied from the hydrogen tank 110.

In this case, an open state and a close state of the HTV 120 may be determined by a fuel cell control unit (FCU) 230. In this case, the FCU 230 outputs a control signal corresponding to a hydrogen manufacturing unit (HMU) 210, when the open state or the close state of the HTV 120 is determined. Accordingly, the HMU 210 may open or close the HTV 120 in response to the control signal from the FCU 230.

When hydrogen is started to be supplied to the fuel cell stack 170, as the HTV 120 is open, and when the pressure of hydrogen introduced into the fuel cell stack 170 is increased, the inner part of the fuel cell stack 170 may be broken or damaged. Accordingly, it is significantly important to manage the pressure of hydrogen. Accordingly, the regulator 130 functions as adjust (reduce) the pressure of hydrogen supplied along the hydrogen supply line connected to the hydrogen tank 110 and the fuel cell stack 170 when the HTV 120 is open.

The regulator 130 may be a medium-pressure regulator that adjusts high-pressure hydrogen gas supplied from the hydrogen tank 110 to medium-pressure hydrogen gas. In this case, the medium-pressure regulator may be provided together with a medium-pressure sensor (not illustrated) to sense the pressure of hydrogen reduced by the regulator and a bending valve (not illustrated) open for a specific time to adjust the pressure of gas, when the pressure sensed by the medium-presser sensor is not adjusted to pressure in the range available for the fuel cell stack 170.

The FCV 140 may be placed between the hydrogen tank 110 and the FSV 150 on the hydrogen supply line to cut off the supply of the hydrogen exhausted from the hydrogen tank 110 to the fuel cell stack 170. For example, the FCV 140 may be open in a start-on state of the fuel cell system and may be closed in a start-Off state of the fuel cell system.

The FSV 150 may be placed between the FCV 140 and the fuel cell stack 170 on the hydrogen supply line, to adjust the pressure of hydrogen supplied to the fuel cell stack 170. For example, the FSV 150 may be open such that hydrogen pressure is increased, when the pressure of the hydrogen supply line is reduced, and may be closed to reduce the pressure of hydrogen, when the pressure of the hydrogen supply line is increased.

In addition, a fuel purge valve (FPV) 160 may be additionally provided between the FSV 150 and the fuel cell stack 170 on the hydrogen supply line.

The FPV 160, which is a valve open and closed to manage hydrogen concentrations in the fuel cell stack 170 and the hydrogen supply line to be maintained in a specific range.

The fuel cell stack 170 may generate electrical energy by using hydrogen and air. While the fuel cell stack 170 is driven in a normal state, the FPV 160 may be closed.

In this case, the air supplied to the fuel cell stack 170 includes nitrogen in addition to oxygen, and crossover is caused to reduce the cell voltage due to the difference in nitrogen partial pressure between the anode and the cathode. Accordingly, the FPV 160 increases the hydrogen concentration in the anode by exhausting the residual hydrogen to decrease a nitrogen concentration, such that stack performance is maintained. The FPV 160 may be controlled to be open to purge hydrogen, such that the hydrogen concentration in the anode is maintained to be a specific amount or more, when an accumulated current calculated by integrating a current generated during a specific period exceeds a target value in the fuel cell stack 170.

In this case, the FCV 140, the FSV 150, and the fuel purge valve (FPV) 160 may be open or closed by the FCU 230.

In addition, the fuel cell stack 170 may be connected to a high voltage battery 50. The high voltage battery 50 may provide auxiliary power to the fuel cell system, and may be charged with regenerative braking energy generated from the fuel cell stack 170.

The HMU 210 is a controller to perform the overall function for supplying hydrogen. In this case, the HMU 210 may be a hardware device, such as a processor or a central processing unit (CPU), or a program implemented by a processor.

The HMU 210 determines the state of the hydrogen tank 110 in real time, and determines whether the state of the hydrogen tank 110 satisfies a condition for controlling hydrogen. For example, the HMU 210 may determine the internal pressure and the internal temperature of the hydrogen tank 110 and may determine the hydrogen concentration and the state of fuel (SoF) of the hydrogen tank 110. Accordingly, the HMU 210 may control operations for supplying hydrogen depending on the state of the hydrogen tank 110.

In addition, the HMU 210 transmits information on the state of the hydrogen tank 110 to the FCU 230. Accordingly, the FCU 230 may control the operation of the fuel cell stack 170, based on the information on the state of the hydrogen tank 110, which is received from the FCU 230.

The FCU 230 is connected to each component of the fuel cell system to perform the overall function related to the management and the operation of the fuel cell system. The FCU 230 may be an upper controller. In this case, the FCU 230 may be a hardware device, such as a processor or a central processing unit (CPU), or a program implemented by a processor.

The FCU 230 may manage the state of the fuel cell stack 170 by controlling the operations of the FCV 140, the FSV 150, and the FPV 160 during the operation of the fuel cell system.

Meanwhile, a hydrogen exhaust valve 125 may be provided in another outlet of the hydrogen tank 110. The hydrogen exhaust valve 125 may have a passage for passing hydrogen, which is wider in area than the passage of the HTV 120, such that remaining hydrogen is rapidly exhausted from the inner of the hydrogen tank 110. In this case, the HTV 120 may be open or closed by the FCU 230.

When a flying object having the fuel cell system is faulted, the flying object may be fallen with hydrogen remaining in the hydrogen tank 110. In this case, a dangerous situation such as explosion of hydrogen remaining in the hydrogen tank 110 may be caused due to an impact in falling. Accordingly, the FCU 230 may open the hydrogen exhaust valve 125 to rapidly exhaust the remaining hydrogen present from the inner part of the hydrogen tank 110, when the flying object having the fuel cell system is faulted.

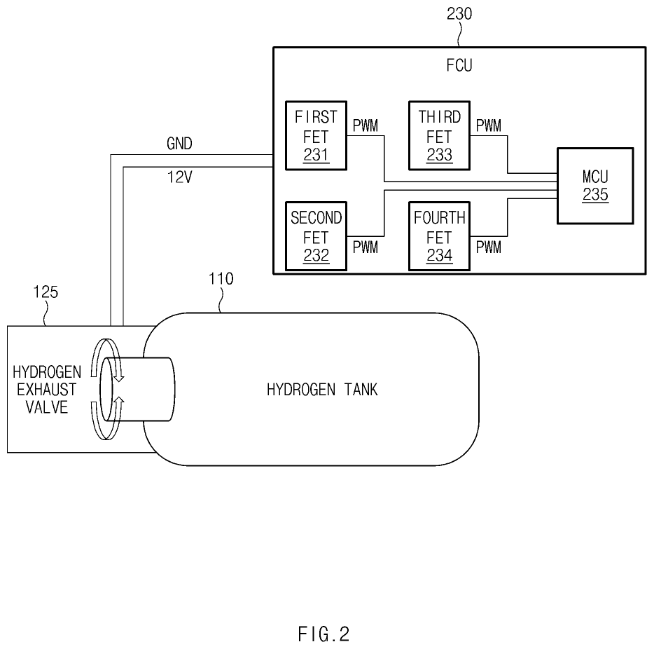

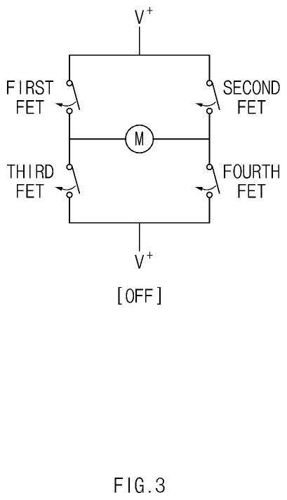

The detailed structure and the detailed operation for controlling the hydrogen exhaust valve 125 in the FCU 230 will be described with reference to FIGS. 2 and 3.

FIG. 2 is a view illustrating the control structure of the hydrogen exhaust valve, according to an embodiment of the present disclosure, and FIG. 3 is a view illustrating the control operation of the hydrogen exhaust valve, according to an embodiment of the present disclosure.

Referring to FIG. 2, the hydrogen exhaust valve 125, which is to exhaust remaining hydrogen present in the hydrogen tank 110, may be realized with a valve to operate by a direction current (DC) motor for a rapid responsiveness in an emergency situation. Accordingly, the hydrogen exhaust valve 125 may be open or closed as the DC motor rotates in one direction or another direction.

The FCU 230 may include an H-bridge circuit including four FETs, that is first to fourth FETs 231 to 234, and a micro-control unit (MCU) 235 to control the operation of the H-bridge circuit, such that the opening or closing operation of the hydrogen exhaust valve 125 is controlled. The MCU 235 may control the first to the fourth FETs 231 to 234 including the H-bridge circuit to open or close the gate, thereby controlling the rotating operation of the DC motor.

Referring to FIG. 3, the MCU 235 may control four FETs, that is first to fourth FETs 231 to 234, to open all gates. In this case, as a circuit is disconnected from the DC motor, the supply of power to the DC motor of the hydrogen exhaust valve 125 is cut off, so the hydrogen exhaust valve 125 is turned off.

In addition, the MCU 235 may control to close a gate, which is connected to the first FET 231 or the fourth FET 234, or to close a gate, which is connected to the second FET 232 or the third FET 233, from the second FET 232 or the third FET 233 In this case, as a current flows leftward of the DC motor, or flows rightward of the DC motor, the DC motor of the hydrogen exhaust valve 125 is rotated.

For example, the MCU 235 controls to open the gate connected to the first FET 231 and the fourth FET 234, and to close the gate connected to the second FET 232 and the third FET 233. In this case, as a current flows leftward of the DC motor, the DC motor rotates in a first direction (forward). In this case, as the DC motor is rotated in the first direction (forward), that is, a closing direction, the hydrogen exhaust valve 125 may be closed.

For another example, the MCU 235 controls to close the gate connected to the first FET 231 and the fourth FE4 234, and to open the gate connected to the second FET 232 and the third FET 233. In this case, as a current flows rightward of the DC motor, the DC motor rotates in a second direction (reverse). In this case, as the DC motor is rotated in the second direction (Reverse), that is, in an open direction, the hydrogen exhaust valve 125 may be open.

The FCU 230 may receive information on the state of a flying object having the fuel cell system, through the communication with a vehicle control unit (VCU) 250 of the flying object. In this case, the FCU 230 may determine the fault state of the flying object during the flight of the flying object, based on the information received from the vehicle control unit (VCU) 250 of the flying object. The FCU 230 analyzes a fault cause, when the flying object is faulted during the flight of the flying object, and diagnoses whether the fuel cell stack 170 is faulted or a vehicle body is defective.

When the fault cause is the fault of the fuel cell stack 170, the vehicle body is not defective, so the posture of the flying object is controlled. In this case, the FCU 230 switches a power supply mode to a high-voltage use mode. When the state of charge (SoC) of the high voltage battery 50 satisfies the condition of being capable of flying to the remaining flight distance, herein, the remaining flight distance may imply a gliding distance based on the height of the flying object at the time of the fault. Furthermore, the remaining flight distance may imply the gliding distance combined with the power remaining in the high voltage battery. The FCU 230 performs a first control operation to exhaust hydrogen within a flying time of the flying object.

The FCU 230 cuts off the supply of hydrogen to the fuel cell stack 170 when performing a first control operation, and supplies auxiliary power to the high voltage battery 50, such that the flying object flies at a lower sped with the minimum power and tries to make emergency landing. In this case, the FCU 230 determines the SoF of the hydrogen tank 110 while the flying object flies at the lower speed for the emergency landing, and opens the hydrogen exhaust valve 125 to exhaust the remaining hydrogen.

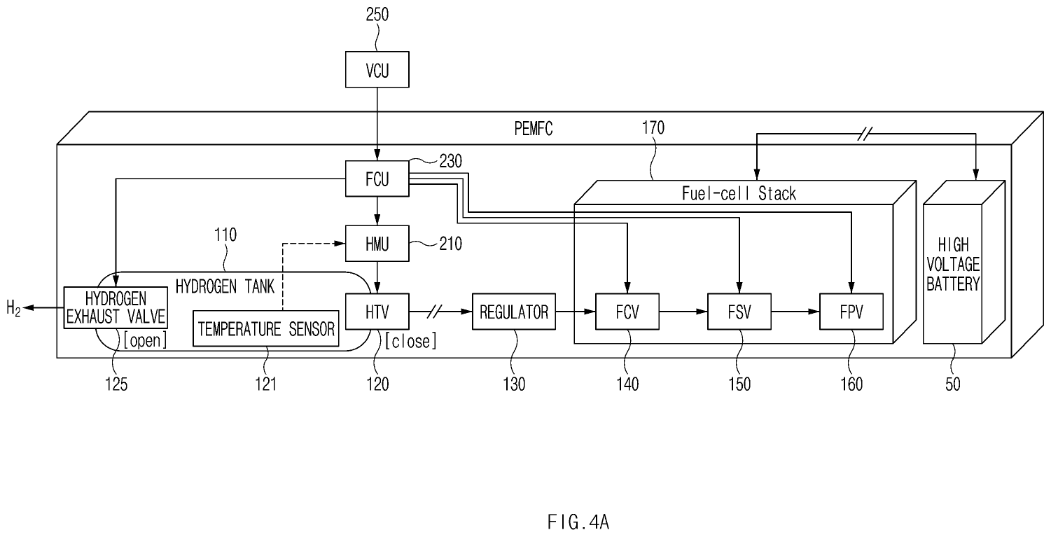

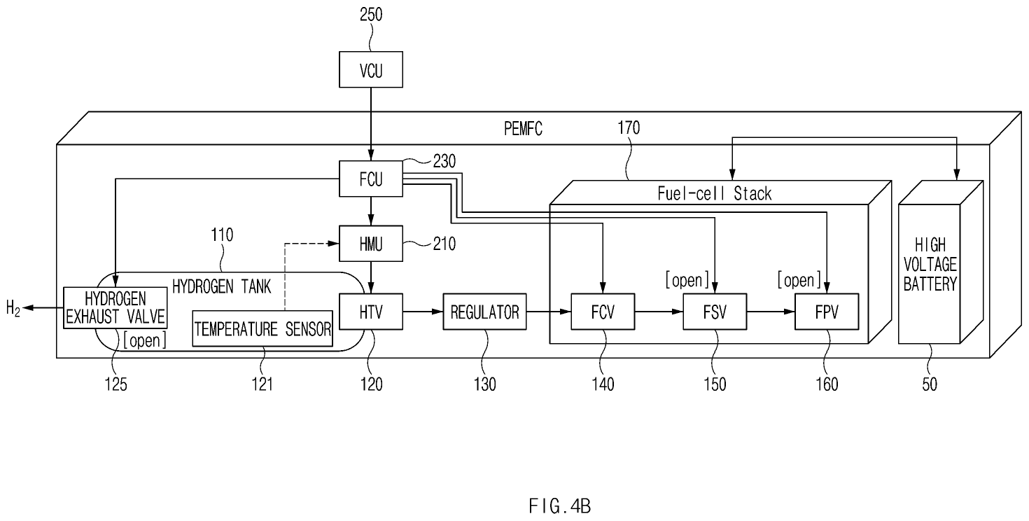

Hereinafter, a hydrogen exhaust operation through a first control operation when the posture of the flying object is able to be controlled, will be described with reference to FIG. 4A.

FIG. 4A is a view illustrating the hydrogen exhaust operation of a fuel cell system, according to an embodiment of the present disclosure. Referring to FIG. 4A, the FCU 230 performs the first control operation, when the flying object is faulted due to the fault of the fuel cell stack 170.

In this case, the FCU 230 stops the charging of the high voltage battery 50 with regenerative braking energy of the fuel cell stack 170 In addition, the FCU 230 closes the HTV 120 to cut off the supply of the hydrogen to the fuel cell stack 170.

As the supply of the hydrogen to the fuel cell stack 170 is cut off, the fuel cell stack 170 may not supply power for the flight of the flying object. Accordingly, the FCU 230 allows the high voltage battery 50 to supply the auxiliary battery to the flying object. In this case, the FCU 230 supplies the minimum auxiliary power allowing the flight of the flying object. In addition, the FCU 230 terminates the operations of power electronic parts except for a bi-directional high voltage DC-DC converter (not illustrated) interposed between the fuel cell stack 170 and the high voltage battery 50.

Accordingly, the vehicle control unit (VCU) 250 of the flying object employs the auxiliary power from the high voltage battery 50 as a propulsion power source such that the flying object flies at a lower speed to try to make the emergency landing to a target position.

In this case, crash may be occurred while the flying object is making the emergency landing while flying at a lower speed. Accordingly, the FCU 230 determines the SoF of the hydrogen tank 110 to open the hydrogen exhaust valve 125 such that the remaining hydrogen is exhausted, while the flying object is making the emergency landing while flying at the lower speed

However, when the SoC of the high voltage battery 50 is less than a reference value, the FCU 230 determines that it is difficult to supply the auxiliary power for the flight of the flying object and performs the second control operation, which is similar to the fault caused by the vehicle body defective.

Meanwhile, when the fault cause is caused by the vehicle body defective, it is difficult to control the posture of the flying object due to the vehicle body defective. In this case, the flying object may be fallen at a rapid speed. Accordingly, the FCU 230 performs a second control operation to exhaust the maximum amount of hydrogen within a shorter time.

The FCU 230 copes with the collision accident caused in emergency landing of the flying object by opening the hydrogen exhaust valve 125, the FSV 150, and the FPV 160 while performing the second control operation, and increasing the output (rpm) of the air supply pump (ACP) to supply the air to the fuel cell stack 170, such that the maximum amount of hydrogen is discharged within the shorter time.

Hereinafter, a hydrogen exhaust operation n through a second control operation when the posture of the flying object is not able to be controlled, will be described with reference to FIG. 4B.

FIG. 4B is a view illustrating the hydrogen exhaust operation of a fuel cell system, according to another embodiment of the present disclosure. Referring to FIG. 4B, the FCU 230 performs the second control operation, when the flying object is failed due to the vehicle body defective.

In this case, the FCU 230 opens the hydrogen exhaust valve 125 to discharge remaining hydrogen to the outside, while opening the FSV 150 and the FPV 160 to the maximum degree.

When the FSV 150 is open to be the maximum degree, the pressure of the hydrogen supply line is increased, and an amount of hydrogen to be supplied to the fuel cell stack 170 is increased. In addition, as the FPV 160 is open to the maximum degree, the hydrogen leaks.

In this case, the FCU 230 consumes remaining hydrogen more rapidly by making, to be the maximum degree, the power (rpm) of the air supply pump (ACP) (not illustrated) to supply the air to the fuel cell stack 170 and increasing an amount of power generated in the fuel cell stack 170, such that hydrogen is exhausted more rapidly before the landing of the flying object.

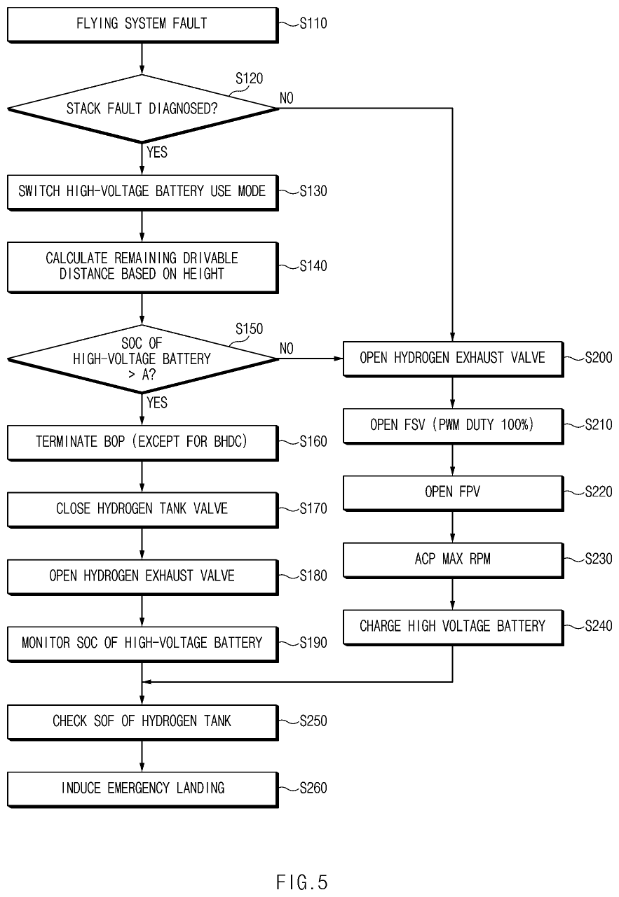

Hereinafter, the operation flow of the fuel cell system having the above configuration will be described in more detail according to the present disclosure. FIG. 5 is a flowchart illustrating the operation of a hydrogen exhaust method of a fuel cell system, according to an embodiment of the present disclosure.

Referring to FIG. 5, when the fuel cell system is faulted while the flying object is flying (S110), the fuel cell system analyzes the fault cause to diagnose whether the fuel cell stack 170 is faulted or the vehicle body is defective.

When the fault cause of the flying object is the fault of the fuel cell stack 170 (S120), the posture of the flying object is able to be controlled. Accordingly, the power supply mode is switched to the high voltage battery use mode (S130). In this case, the fuel cell system calculates the remaining flight distance based on the current height of the flying object (S140) and determines whether the remaining amount of the high voltage battery 50 exceeds a reference value “a” calculated based on the remaining flight distance. The fuel cell system performs the first control operation to exhaust hydrogen within the flying time of the flying object, when the SoC of the high voltage battery 50 exceeds the reference value “a” calculated based on the remaining flight distance (S150)

The fuel cell system stops the charging of the high voltage battery 50 with the regenerative braking energy of the fuel cell stack 170, and supplies the propulsion power of the flying object with the charging power of the high voltage battery 50, when performing the first control operation. In this case, to ensure the charging power of the high voltage battery 50, the operations of the power electronic parts (BOP) except for the BHDC (not illustrated) interposed between the fuel cell stack 170 and the high voltage battery 50 are terminated to ensure the charging power of the high voltage battery 50.

In addition, the fuel cell system closes the HTV 120 to cut off the supply of the hydrogen to the fuel cell stack 170 (S170) and opens the hydrogen exhaust valve 125 to exhaust the remaining hydrogen of the hydrogen tank 110 (S180), to cut off the supply of the hydrogen to the fuel cell stack 170, when performing the first control operation.

The fuel cell system monitors the SoC of the high voltage battery 50 while supplying, as the propulsion power of the flying object, the charging power of the high voltage battery 50 (S190).

Thereafter, the fuel cell system determines the SoF of the hydrogen in the hydrogen tank 110 (S250) and induces the flying object to try the emergency landing (S260).

Accordingly, the vehicle control unit (VCU) 250 of the flying object employs the power from the high voltage battery 50 as a propulsion power source such that the flying object flies at a lower speed to try to make the emergency landing to a target position.

Meanwhile, when the fault cause of the flying object is determined as being the vehicle body defective rather than the fault of the fuel cell stack 170 in S120, or when the SoC of the high voltage battery 50 is determined as being the reference value ca′, which is calculated based on the remaining flight distance, or less, the fuel cell system determines that it is difficult to control the posture of the flying object to perform the second control operation of discharging the maximum amount of hydrogen within a shorter time.

The FCU 230 opens the hydrogen exhaust valve 125 to exhaust the remaining hydrogen in the hydrogen tank 110 to the outside, when performing the second control operation (S200). In addition, the FCU 230 opens the FSV 150 and the FPV 160 to be the maximum degree (S210 and S220).

In addition, the fuel cell system makes the power (rpm) of the air supply pump (ACP) (not illustrated) to supply the air to the fuel cell stack 170 to be at the maximum degree (S230) and charges the high voltage battery 50 with power generated in the fuel cell stack 170, to more rapidly consume the remaining hydrogen in the hydrogen tank 110 by increasing an amount of power generated in the fuel cell stack 170 (S240).

Thereafter, the fuel cell system determines the SoF of the hydrogen tank 110 (S250) and induces the flying object to try the emergency landing (S260).

In this case, the vehicle control unit (VCU) 250 of the flying object may not exactly control the posture of the flying object due to the vehicle body defective, but may perform a possible control operation such that the emergency landing is made with the minimum impact.

As described above, according to an embodiment of the present disclosure, in the fuel cell system and the hydrogen exhaust method thereof, when the fault is made while lying object having the fuel cell system is driven, the hydrogen exhaust valve 125 is controlled and the remaining hydrogen is rapidly discharged from the hydrogen tank 110. Accordingly, the risk of hydrogen explosion caused by the collision may be minimized in the emergency landing.

As described above, according to an embodiment of the present disclosure, the hydrogen exhaust valve may be provided in the hydrogen tank to rapidly exhaust hydrogen, and the hydrogen exhaust valve in fault of the flying object having the fuel cell system during moving may open to rapidly exhaust the remaining hydrogen in the hydrogen tank.

According to an embodiment of the present disclosure, the remaining hydrogen in the hydrogen tank may be rapidly exhausted in mutually different manners depending on the fault causes, in fault of a flying object having a fuel cell system during moving, thereby minimizing the risk of the hydrogen explosion accident caused by crash in emergency landing.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A fuel cell system, comprising:
a hydrogen exhaust valve provided in an outlet of a hydrogen tank, the hydrogen tank configured to supply hydrogen to a fuel cell stack, the hydrogen exhaust valve being configured to exhaust remaining hydrogen in the hydrogen tank to an outside; and
a controller configured to:
diagnose a fault cause when a fault occurs during a flight of a flying object associated with the fuel cell stack;
perform an exhaust operation on the hydrogen stored in the hydrogen tank responsive to the fault cause; and
control the hydrogen exhaust valve according to the exhaust operation.

2. The fuel cell system of claim 1, wherein the controller is further configured to:
diagnose the fault cause, based on information on a state of the flying object, the information being received through a communication with a vehicle controller of the flying object.

3. The fuel cell system of claim 2, further comprising:
a high voltage battery configured to be charged with regenerative braking energy of the fuel cell stack, and to supply a propulsion power to the flying object responsive to the fault cause being a fault from the fuel cell stack.

4. The fuel cell system of claim 3, wherein the controller is configured to:
switch a power supply mode to a high-voltage battery use mode when the fault cause of the flying object is the fault from the fuel cell stack; and
perform a first control operation responsive to a state of charge (SoC) of the high voltage battery satisfying a condition of being capable of flying for a remaining flying distance.

5. The fuel cell system of claim 4, wherein the controller is configured to:
stop a charging of the high voltage battery with the regenerative braking energy of the fuel cell stack; and
supply the propulsion power of the flying object for an emergency landing operation of the flying object using a charging power of the high voltage battery, when the first control operation is performed.

6. The fuel cell system of claim 5, wherein the controller is configured to:
terminate an operation of a power electronic part drawing a power of the high voltage battery, when the first control operation is performed.

7. The fuel cell system of claim 2, wherein the controller is configured to:
perform a second control operation, when the fault cause of the flying object is responsive to a defect of a vehicle body of the flying object.

8. The fuel cell system of claim 7, wherein the controller is configured to, during the second control operation:
open the hydrogen exhaust valve; and
open a fuel supply valve to adjust supply of the hydrogen to the fuel cell stack, and a purge valve, to perform a purge operation for the fuel cell stack.

9. The fuel cell system of claim 8, wherein the purge operation is configured to fully discharge the hydrogen in a minimum amount of time.

10. The fuel cell system of claim 8, wherein the controller is configured to:
operate an air supply pump to supply air to the fuel cell stack to output a maximum power, when the second control operation is performed.

11. The fuel cell system of claim 10, wherein the controller is configured to:
charge a high voltage battery with the power generated in the fuel cell stack, when the second control operation is performed.

12. The fuel cell system of claim 8, wherein the controller is configured to:
perform the second control operation, when the fault cause of the flying object is a fault of the fuel cell stack, and when a state of charge (SoC) of a high voltage battery does not satisfy a condition being capable of flying driving to a remaining flight distance.

13. A method for exhausting hydrogen in a fuel cell system, the method comprising:
diagnosing a fault cause when a fault occurs during a flight operation of a flying object being propelled with power generated in a fuel cell stack;
performing an operation of controlling an exhaust of the hydrogen responsive to a diagnosis result; and
controlling a hydrogen exhaust valve to exhaust remaining hydrogen in a hydrogen tank to an outside.

14. The method of claim 13, wherein the controlling of the hydrogen exhaust valve includes:
switching a power supply mode to a high-voltage battery use mode when the fault cause of the flying object is a fuel cell stack fault;
performing a first control operation, when a state of charge (SoC) of the high-voltage battery satisfies a flying condition for a remaining flight distance; and
performing a second control operation, when the fault cause of the flying object is a vehicle body fault of the flying object.

15. The method of claim 14, wherein the performing of the first control operation comprises:
stopping a charging of the high-voltage battery from a regenerative braking energy of the fuel cell stack;
initiating supplying the propelling power of the flying object from the high-voltage battery;
terminating an operation of one or more power electronic parts drawing power of the high-voltage battery;
closing a hydrogen tank valve supplying the hydrogen to the fuel cell stack, and opening the hydrogen exhaust valve; and
monitoring the SoC of the high-voltage battery to determine a remaining amount of hydrogen in the hydrogen tank.

16. The method of claim 14, wherein the performing of the second control operation comprises:
opening the hydrogen exhaust valve;
opening a fuel supply valve, to adjust a supply of the hydrogen to the fuel cell stack, and a purge valve to perform a maximum purge operation for the fuel cell stack;
operating an air supply pump to supply air to the fuel cell stack to output a maximum power; and
charging the high-voltage battery with the power generated in the fuel cell stack.

17. The method of claim 14, wherein the controlling of the hydrogen exhaust valve comprises:
performing the second control operation, when the fault cause of the flying object is the fuel cell stack fault, and when a state of charge (SoC) of the high-voltage battery to supply propulsive power to the flying object does not satisfy a condition for fight to a remaining flying distance.

18. A processor-implemented method, the method comprising:
monitoring for faults during a flight operation of a flying vehicle being propelled by a fuel cell stack employing a hydrogen tank storing hydrogen and a battery being charged with regenerative braking energy from the fuel cell stack; and
responsive to a fuel cell stack fault, entering an emergency landing operation, the emergency landing operation comprising controlling a valve of the hydrogen tank to release the hydrogen.

19. The method of claim 18, further comprising:
responsive to a flying body fault, entering an emergency venting operation, the emergency venting operation comprising:
performing a purge operation to release the hydrogen.

20. The method of claim 19, wherein the purge operation comprises:
opening a hydrogen exhaust value to vent the hydrogen from the hydrogen tank;
closing off a supply of the hydrogen to the fuel cell stack;
suppling air to the fuel cell stack via an air supply pump; and
charging the battery with power from the fuel cell stack, and
wherein the emergency landing operation further comprises:
ceasing the battery being charged with the regenerative braking energy;
switching to a propulsion power supplied by the battery;
switching off one or more power electronic parts of the flying vehicle being powered by the battery;
closing a supply of hydrogen from the hydrogen tank to the fuel cell stack; and
opening a hydrogen exhaust value to vent the hydrogen from the hydrogen tank.
